(19) United States
(12) Patent Application Publication
(10) Pub. No.: US 2013/0320880 A1
(43) Pub. Date: Dec. 5, 2013

(54) RMS RESPONDING VOLTAGE CONVERTER FOR LED LIGHTS

(71) Applicant: James T. Walker, Palo Alto, CA (US)

(72) Inventor: James T. Walker, Palo Alto, CA (US)

(21) Appl. No.: 13/896,240

(22) Filed: May 16, 2013

Related U.S. Application Data
(60) Provisional application No. 61/647,599, filed on May 16, 2012.

(51) Int. Cl. H05B 37/02

(52) U.S. Cl. CPC H05B 37/02
USPC 315/294; 363/125

(57) ABSTRACT

An RMS responding voltage converter for LED lights is disclosed.

### PRIORITY CLAIM

This application claims priority under 35 U.S.C. Section 119 and 120 to U.S. Provisional Patent Application Ser. No. 61/647,599 filed on May 16, 2012, which is incorporated by reference herein.

### TECHNICAL FIELD

An RMS responding voltage converter for LED lights is disclosed.

### BACKGROUND OF THE INVENTION

A light emitting diode (LED) lighting system requires a power converter for changing the AC line voltage received from the utility power line to the DC power specific to the LED load circuit. This power converter has many requirements, some of which are small size, simplicity, efficiency, and high power factor. Power factor is a measure of the input impedance of the power converter in this application, with a value of 1.0 being the ideal value produced by a pure resistive load. When the power factor is less than 1.0, the load under consideration draws more input current than a purely resistive load would draw, for the same amount of real power consumed. Many electronic power converters have power factors of 0.7 or less, with some being as poor as 0.4. Regulatory agencies sometimes require a power factor of greater than 0.90. This is to prevent problems with the AC power distribution system being loaded by current flows which do not do useful work.

### SUMMARY OF THE INVENTION

One objective of this disclosure is a power converter for an LED system which will provide an input power factor close to 1.0 using a simple circuit. Another objective is to provide power conversion in a small size with a minimum of expensive components. The design proposed here uses only one inductor or transformer and one high voltage power switch to achieve that goal. A further object is achievement of efficiency and small size. This can be achieved by careful choice of the operating frequency and components used. A further object is capability of operation with all types of lamp brightness dimmer controls. Satisfactory operation with leading edge and trailing edge phase cut lamp dimmers, digitally controlled dimmers, as well as transformer type dimmers is desired. A further object is regulation of the LED lamp brightness over the range of typical operating input voltages to achieve constant brightness. Measurement of the input voltage and active compensation for variations permits constant brightness operation. A further object is provision of control circuits to give proper operation in a three way lamp installation. Three way light bulbs incorporate two filaments and an extra contact on their base to permit choice of three different brightness levels in a standard light fixture. Control circuits to emulate this type of operation are provided. A further object is the provision of means for adjustment of the power converter output value by either the factory or the light bulb manufacturer to standardize the LED brightness at a desired value and compensate for manufacturing variations. Circuits are provided which allow adjustment of the chip after manufacturing to have a desired standard characteristic, and adjustment of the assembled application circuit to compensate for characteristics of components such as the LEDs and inductor.

### BRIEF DESCRIPTION OF THE DRAWINGS

FIG. 1 depicts a power converter for an LED load.

FIG. 2 depicts timing information for the power converter of FIG. 1.

FIG. 3 depicts equations relevant to the operation of the power converter of FIG. 1.

FIG. 4 depicts equations relevant to LED power and current control.

FIG. 5 depicts an embodiment of an RMS responding voltage converter.

FIG. 6 depicts an embodiment of a peak detect circuit.

FIG. 7 depicts equations relevant to charging current for constant power.

FIG. 8 depicts an embodiment of a shaper circuit.

FIG. 9 depicts a response of a shaper circuit.

FIG. 10 depicts an embodiment of a voltage sample circuit.

FIG. 11 depicts an embodiment of a power converter with auxiliary load.

FIG. 12 depicts an embodiment of a DDC circuit.

FIG. 13 depicts an embodiment of a leading edge blanking circuit.

FIG. 14 depicts embodiments of a pulse generator, control logic, and gate driver.

FIG. 15 depicts an embodiment of a floating OVP detector.

FIG. 16 depicts an embodiment of a non-linear filter.

FIG. 17 depicts an embodiment of a digital-to-analog converter.

FIG. 18 depicts an embodiment of a factory trim circuit.

### DETAILED DESCRIPTION OF THE PREFERRED EMBODIMENTS

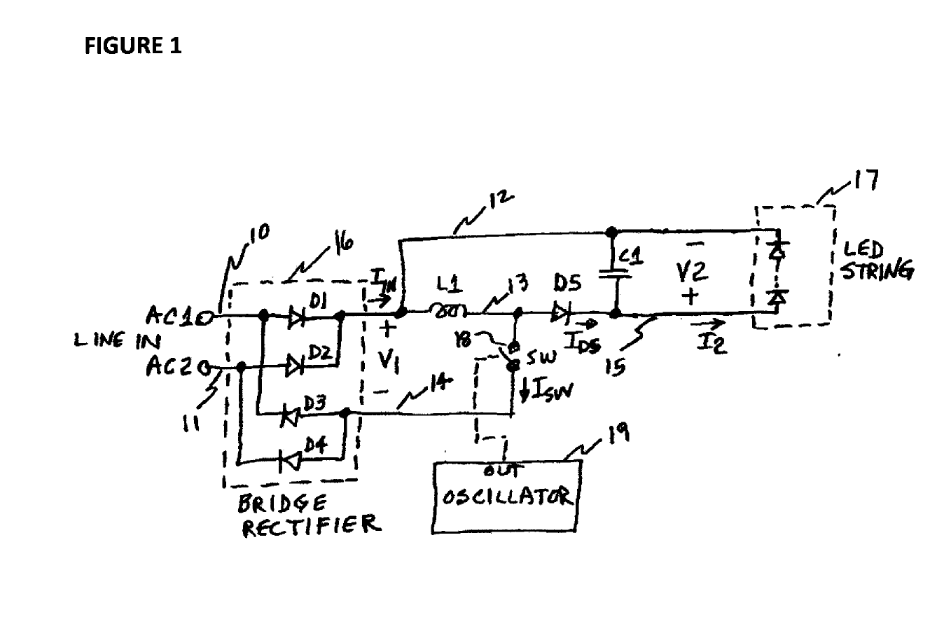

Consider the voltage converter shown in FIG. 1. In this converter an AC sine wave line voltage input from wires 10 and 11 goes first through a bridge rectifier 16, composed of diodes D1 through D4 as is well known in the state of the art. The output of the rectifier 16 is a unipolar voltage V1 with positive polarity on wire 12 and negative polarity on wire 14. This voltage is a full-wave rectified sine wave for the circuit shown, and may be viewed as a source of pulsating DC voltage. The output current of the bridge rectifier 16 is labeled Iin, flowing out of the positive terminal of the rectifier. This current will also be the same as the switch current Isw as denoted flowing in wire 14.

An inductor L1 is provided in series with an electronic switch 18 to complete the current path back to the negative terminal of the bridge rectifier 16 on wire 14. The switch 18 turns on and applies the input voltage to the inductor L1. If the input voltage is considered to be essentially constant during the time switch 18 is closed, the current will increase in a linear fashion according to the equation V=L*di/dt. When switch 18 opens, the voltage on wire 13 makes a large positive transition, causing the inductor current to flow through diode D5 into the LED load string 17. An optional capacitor C1 may be connected in parallel with the LED string 17 to provide temporary storage of charge, so that the current through the LED string 17 has less variation due to the inductor current pulses. If the capacitor is large enough, it may also provide smoothing of LED current variations caused by the incoming AC line voltage sine wave pulses. In some applications it may be possible to omit both D5 and C1, relying on the diode properties of the LED string instead to regulate the current flow direction.

As will be shown later, if switch 18 is operated for a fixed amount of time each time it is turned on, and at a constant frequency of switch closure, then this circuit has the desirable property of automatically providing power factor correction on its AC input. An oscillator 19 is provided to control the switch operation to achieve this goal. The oscillator is made so that it has a minimum of variation of its output pulse width and frequency with temperature and supply voltage. Use of a stable oscillator permits a circuit which does not require measurement of the input current or voltage, or use of feedback from the LED load circuit to achieve the desired high power factor operation objective. This is a key provision of this invention.

The circuit of FIG. 1 is commonly referred to as a flyback power converter, usually used with some type of output sensing and feedback to achieve a desired operating characteristic. However, as will be shown below, if certain operating constraints are met, the circuit will provide the desired high power factor operation in a simple circuit without feedback.

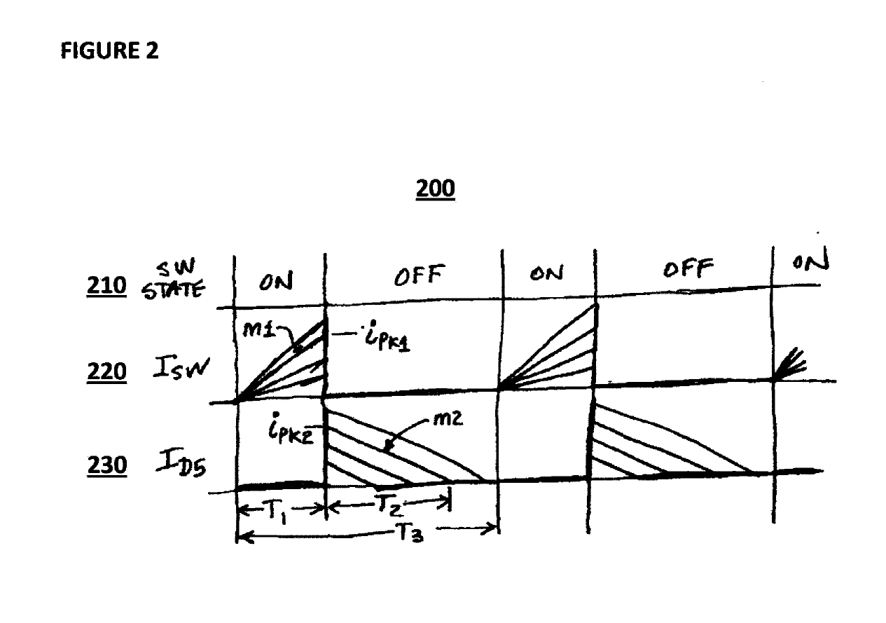

FIG. 2 shows relevant operation waveforms 200 for the circuit of FIG. 1. The first row 210 denotes the switch state versus time, the second row 220 shows the current through switch 18, and the third row 230 shows the current through the diode D5. Each time the switch is turned on, the current increases linearly from zero to a peak value Ipk1. After a time T1, the current through the inductor I1 will be I1=Ipk1=(V1*T1)/L1. The slope m1 of the current wave depends proportionally on the incoming rectified voltage V1. Therefore the final current at the end of the time interval T1 is the current Ipk1 which is proportional to V1.

When the switch turns off, the voltage on wire 13 makes a fast positive transition until diode D5 conducts. The current in diode D5 then flows according to the waveform shown for Id5. This current begins at a value Ipk2 and linearly decreases to zero, at which time D5 stops conducting current. If parasitic losses due to capacitance and resistance are ignored for now, the peak currents Ipk1 and Ipk2 may be regarded as equal. The rate of fall of Id5 has the slope m2. Since the LED load voltage is essentially constant, the rate of fall is nearly constant, and the time T2 varies according to the initial value of Ipk2. As a result the discharge time T2 is proportional to the initial rectified voltage V1. After diode D5 stops conduction, the inductor current stays at zero current until the next time switch 18 turns on. Presence of stray capacitance causes residual energy to resonate between the inductor L1 and the stray capacitance, generating a ringing waveform on wire 13 until switch 18 turns on again. This ringing is of little consequence to the desired operation of the circuit as described above.

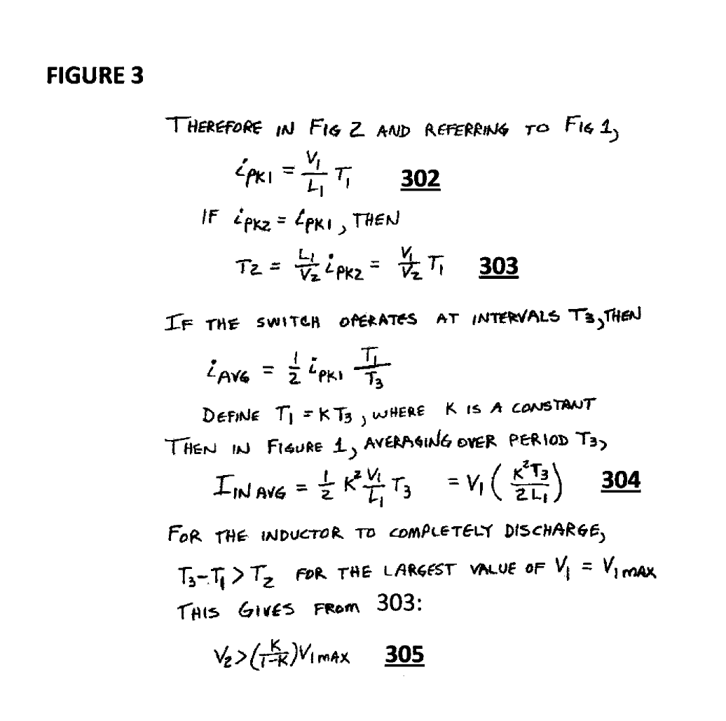

Equations for the operation of the power converter described in FIGS. 1 and 2 are presented in FIG. 3. Equation 302 shows the basic inductor equation. Solving for the charging and discharging conditions gives the basic relation in equation 303 that the discharge time T2=T1*(V1/V2). If the switch operates at intervals T3, the average input current over the cycle period of T3 can be calculated as shown in equation 304. Note that the cycle average input current depends only on the input voltage V1 and the constant values of K, T3, and L1. Since the voltage and current are related by a constant, the effective input impedance Rin=(V1/Iinavg) of the power converter is a constant and does not depend on V1. Therefore the input impedance is purely resistive, without nonlinearities, and will give high power factor operation. This property is made possible by operation of switch 18 for a constant time T1 and with a constant operating period T3. Feedback is not needed to provide this property of high power factor operation. Effects caused by parasitic resistances and capacitances in the circuit will modify this result somewhat, but the basic property of a constant resistance input will exist as the prominent circuit characteristic. Therefore this circuit will provide the important property of a high value of power factor as desired. Equation 304 is crucial to achieving this high power factor operation without feedback.

It is possible on examination of equation 304 that the system can be operated without T3 being constant if the defined factor K=T1/T3 is properly chosen. For this alternative operation mode, it is necessary for the control circuit to maintain the factor K*K*T3 to be a constant, instead of maintaining K and T3 separately as constant values. This operating mode is not favored here, as it appears more complicated that separately controlling T3 and K.

In order for this power converter to operate correctly in a discontinuous current conduction mode, it must start each cycle of operation with the inductor current near zero. Therefore the operating frequency must be chosen so that T2 above is less than the pulse period (T3−T1). If K is the ratio of T1 and the pulse period T3, then the final equation 305 relates the allowed value of the load voltage V2 to the largest input voltage present on V1 and the factor K. For the example application circuit here, V1 has the range 0 to 170 volts as the input 120 VAC line voltage varies, T1=T3/3, that is K=⅓, and V2 is approximately 90 volts. Therefore the requirements of equation 305 are met and discontinuous operation will occur.

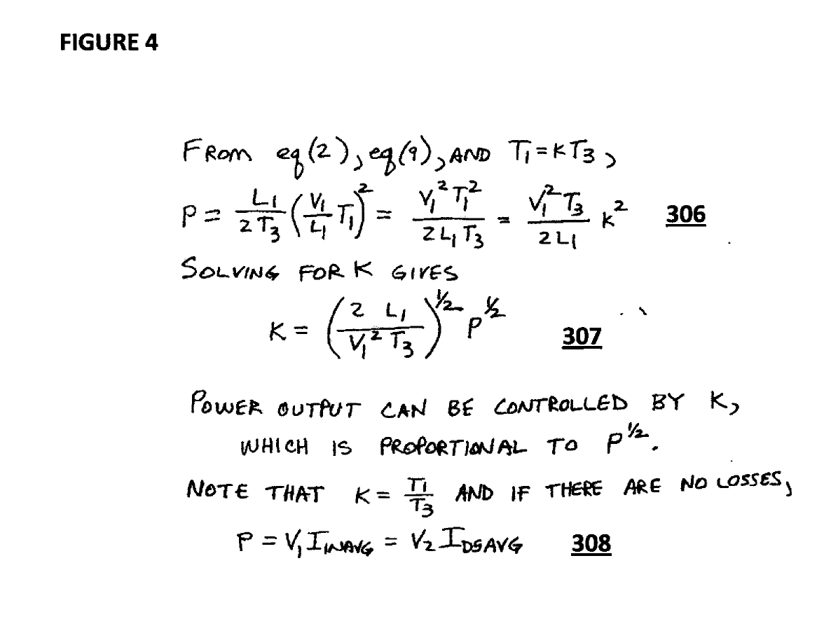

As shown in FIG. 4, several equations from FIG. 3 may be combined to compute the power output of the converter. Using equation 302, equation 309, and T1=K*T3, these equations may be solved to find the relationship between K and the output power P. We see in equation 306 that the power P is proportional to the square of K and the square of the instantaneous input voltage V1. The circuit is RMS responding because the average output power is proportional to the square of the instantaneous input voltage averaged over the input voltage waveform time as shown in equation 306.This means that K, and therefore the pulse width T1, may be varied to change the output power. Solving equation 306 for K gives the formula of equation 307, which shows that K is proportional to the square root of the desired power P. This equation may also be solved to find the proper value of L1 for a particular system output power, given that K, V1, T3, and P are known.

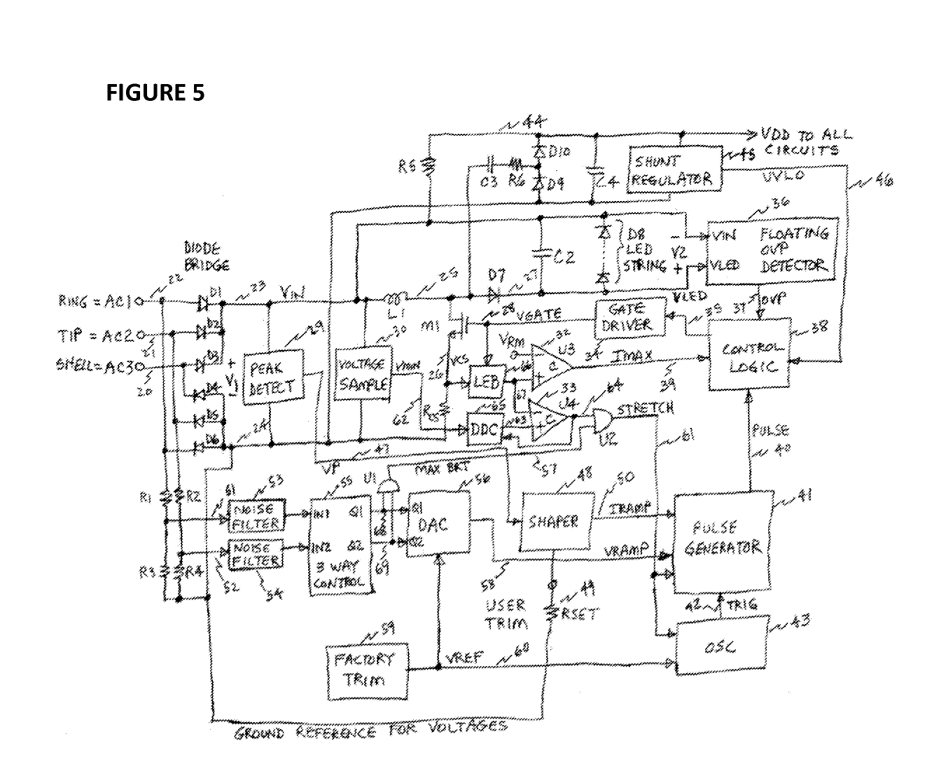

FIG. 5 shows how the circuit of FIG. 1 may be adapted to make a practical RMS responding voltage converter to drive an LED load. This circuit as shown incorporates all the functions mentioned previously in the second paragraph above. Note that for conceptual simplicity, the circuit uses wire 24 as the common reference point for all voltages being discussed. Operation begins with input from an AC voltage source, which is applied between input AC3 on wire 20 and one or both of the inputs AC1 on wire 22 and AC2 on wire 21. Which of the inputs AC1 and AC2 receives incoming power is one of the factors which determine the brightness of the LED lamp. Normally AC2 connects to the tip of the light bulb base, AC3 connects to the screw threaded shell, and AC1 connects to an auxiliary ring contact for three way control. All discussions below include the connection AC1 and associated circuitry for three way control, but this inclusion is not a requirement for proper functioning of the remaining circuits to be detailed here. The noise filter, three way control, and DAC blocks and some miscellaneous logic gates may be omitted without impairing the practical functionality of the remaining power converter circuitry.

The AC line voltage goes first through a diode bridge using D1 through D6 as knows in the state of the art to produce a voltage V1 between wire 23 as the positive terminal and wire 24 as the negative terminal. Using wire 24 as a zero voltage reference for all following discussions, the voltage Vin=V1 is then used as the pulsating power input to the remainder of the circuit. An N channel Metal Oxide Field Effect Transistor (NMOS FET) M1 is used as the switch in the previous discussions. The main power path is current through L1, switch M1, and current sampling resistor Rcs. When voltage Vgate is applied on wire 28 by the gate driver 34, M1 turns on and connects the input voltage Vin across the series combination of L1 and Rcs. Since Rcs is intended only for current measurement by voltage drop, it is a small value. Essentially all of the input voltage Vin appears across L1 and the inductor current ramps up as described previously. When switch M1 turns off, The voltage on wire 25 makes a large positive excursion until diode D7 conducts the inductor current to the load circuit as described before. A capacitor C2 is provided to store charge and smooth out the current pulses from D7 for powering the LED string D8. The voltage appearing on wire 27 to the LEDs is denoted Vled. Since the LED string is referenced to the input voltage Vin, the difference voltage across the LEDs is denoted V2 as before.

Power to operate the various circuits described below is produced by a charge pump circuit using C3, R6, D9, and D10 to rectify the voltage waveform appearing on wire 25, and produce a voltage Vdd on wire 44. The value of C3 determines the average current available, and resistor R6 limits the peak value of transient current when the voltage on wire 25 changes value. Since the circuits require a stable source of operating voltage, a shunt regulator 45 is provided to load wire 44 and maintain constant operating voltage. This regulator incorporates a bandgap voltage reference source, error amplifier, and shunt Mosfet transistor as known in the state of the art. Any type of voltage limiting circuit such as a zener diode or other circuit known to the state of the art could be used to prevent excess voltage on the Vdd wire 44. In order to start operation of the circuit before the power converter with L1 and M1 is operating, an extra high value resistor R5 is incorporated to give an initial charge to the Vdd filter capacitor C4. Under voltage lockout circuits within the shunt regulator put out a signal on the wire 46 to the control logic and other circuits to prevent operation until the voltage Vdd is sufficient. In this way, the resistor R5 can start operation with a very small current of approximately 40 microamps, and capacitor C4 provides the instantaneous current needed for operation until the charge pump with C3 produces additional Vdd supply current. The shunt regulator also has various bias current outputs derived from the bandgap voltage reference and used as needed to power circuitry in other parts of the system.

The constant frequency pulse generation to drive the switch M1 begins with the oscillator 43. This oscillator is designed to have constant frequency versus temperature. The oscillator puts out a nominal square wave at a 75 KHz frequency in the present implementation. This frequency could of course be changed to any other value convenient to the specific design being constructed. The oscillator output Trig on wire 42 then goes to a pulse generator 41. The pulse generator uses a constant current Iramp to charge a capacitor to a voltage Vramp as known in the state of the art. When the capacitor voltage reaches Vramp, the pulse output on wire 40 is terminated. The current Iramp and the voltage Vramp are provided by circuits to be described later. The resulting pulse is nominally 4.4 microseconds, about ⅓ of the period of the oscillator signal Trig on wire 42. This pulse width will vary in accordance to the control signals Iramp and Vramp to achieve desired circuit improvements as discussed later.

The output pulse from the pulse generator then goes to the control logic 38, where it is combined with various signals to determine how to operate the switch M1. Signals such as the under voltage lock out (UVLO) on wire 46, over voltage protection (OVP) on wire 37, and maximum operation current (IMAX) on wire 39 are used to control the switch operation. When the pulse is satisfactory, it is then sent on wire 35 to the gate driver 34. Gate driver 34 provides amplification and additional output current as needed to drive a pulse with fast edges into the capacitance of the Mosfet switch M1. Details of these blocks will be discussed later.

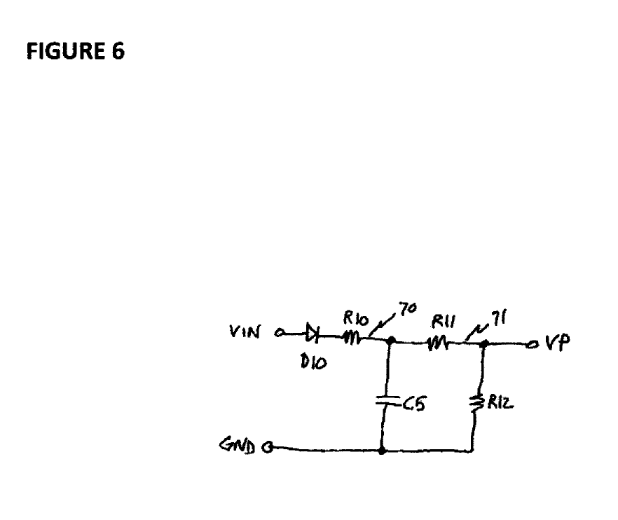

Suppression of light bulb brightness variations with incoming line voltage over a reasonable range of variation is a further object of this invention. In order to provide LED brightness which does not vary for small changes in the incoming AC line voltage, as rectified at Vin, a measure of the line voltage is used to control the pulse generator to make small adjustments in the switch M1 operating time T1. The voltage Vin goes first to a peak detector circuit as shown in FIG. 6. This circuit uses a diode D10 in series with resistor R10 to charge capacitor C5 to the peak value of the input voltage Vin. Recall that Vin is a full wave rectified AC sine wave, so Vin has half-sine voltage excursions at a 120 Hz rate in United States power situations. The time constant of C5 with the load resistors R11 and R12 is made long enough that the voltage on wire 70 decays only a small percentage between half-sine wave peaks. Resistor R10 is provided to prevent fast noise spikes on Vin from causing an erroneously high voltage on wire 70. The objective is that the voltage on wire 70 is a representation of the peak value of the AC sine wave input to the power converter system. That information is used by dividing the voltage using the resistors R11 and R12 to produce a voltage Vp on wire 71.

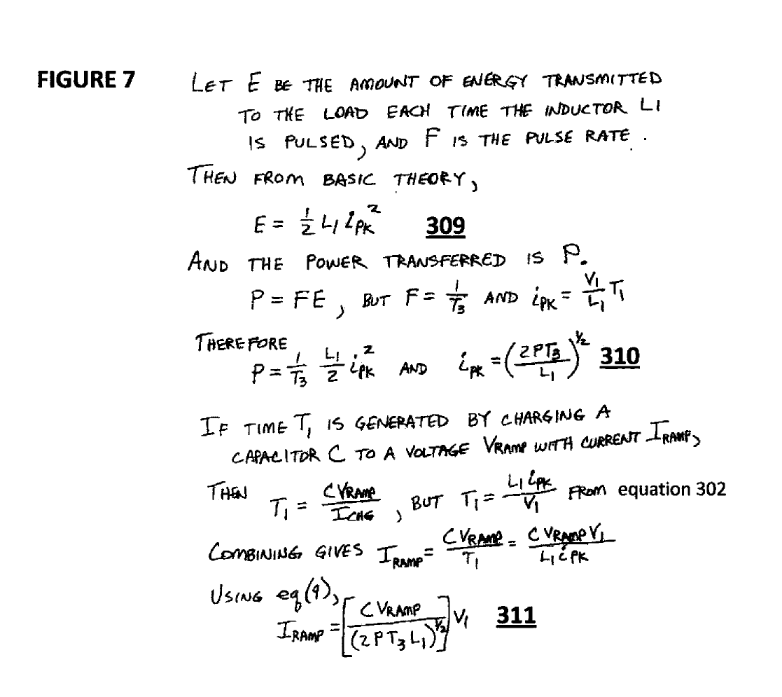

FIG. 7 shows the derivation of the relationship between the pulse generator charging current Iramp and the input voltage V1 required to get constant output power. If P represents the RMS output power to the LED, then the voltage V1 represents the RMS input voltage to the power converter. Since the input waveform is a predictable sine wave, the voltage Vp which is derived from the sine wave peak amplitude is a suitable measure of the RMS value of V1. Small distortions of the sine wave shape will not have important effects on the arguments which follow.

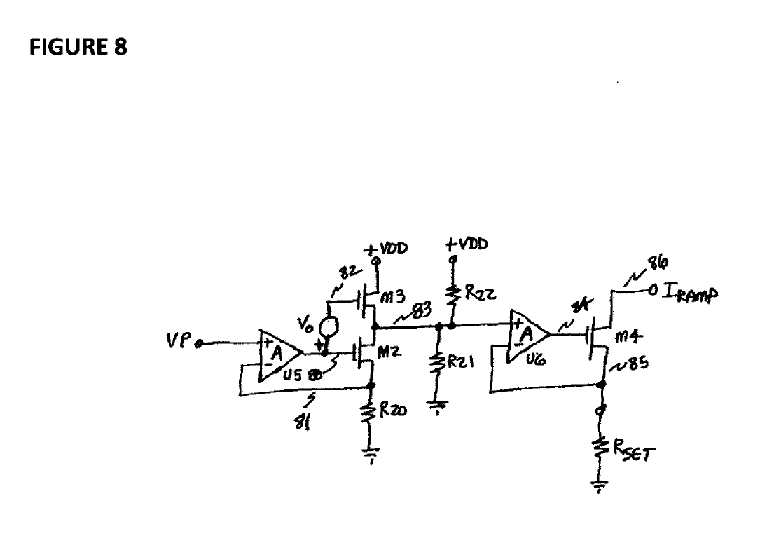

In FIG. 8, the basic equations for the energy E stored in the inductor per pulse as shown in equation 309 are used with the other relations known for the operation of the circuit and timing generation. The result is that the peak inductor current Ipk can be related to the output power P, the pulse frequency T3, and the inductor value L1 as in equation 310. Then by using known information about how the timing ramp T1 is generated as discussed previously, the relation between Iramp and all the parameters which affect its necessary value are shown in equation 311. The important thing here is that all the variables within the square brackets (C, Vramp, P, T3, and L1) are constant for the purposes of this discussion. Therefore to obtain constant RMS power P, it is only necessary that the capacitor charging current Iramp is proportional to the RMS value of the input voltage V1 over the range of V1 where constant power operation is desired. This effect may be obtained by using V1 to control a current source which generates Iramp.

When the RMS input voltage is not in the desired constant power range, some other control protocol needs to be used for Iramp. In FIG. 5 this problem is solved by adding the shaper block 48 between the peak detector 29 and the Iramp on wire 50 to the pulse generator 41. The shaper block is arbitrarily chosen to cause Iramp to be proportional to V1 over a range of +/−15% relative to the normal operating line voltage for the LED lighting application being developed. This percentage range can be varied, but making it wider will place more stringent constraints on how various circuits in the system operate. The chosen values are satisfactory for a light bulb replacement designed to operate on 115V with a constant light output range from 100V to 130V AC input. Input voltages less than 100V will still cause the LED light output to diminish in proportion to the square of the incoming line voltage, just as would happen with a standard tungsten filament light bulb.

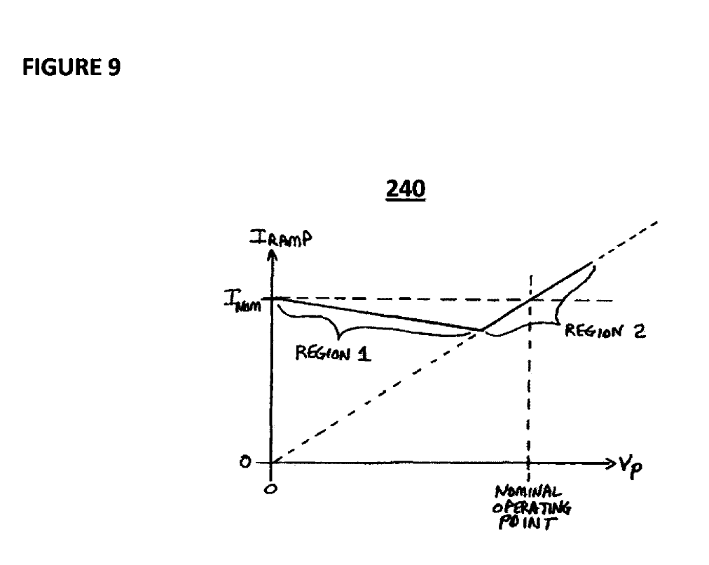

FIG. 8 shows one realization of a suitable shaper circuit for the constant power function, and FIG. 9 shows the resulting voltage-to-current transfer function 240. It is desirable that when the voltage input Vp is zero (which may be an intentional connection), the output of the circuit produces a nominal ramp charging current Iramp=Inom. This is a nominal value of current which produces a standard pulse width from the pulse generator, for those application cases where brightness compensation is not desired, and also corresponds to the brightness level which the circuit is expected to produce if the AC input voltage is the nominal or design center value. Looking at FIG. 8, the shaper circuit uses the peak voltage Vp to control a current sink made up with amplifier U5, transistor M2, and resistor R20.

Consider first that in the case when Vp is zero, this circuit will not draw any current from wire 83, and the voltage on wire 83 will be the nominal value as defined by resistors R21 and R22. This voltage in turn defines an essentially identical voltage across external resistor Rset on wire 85 due to the action of amplifier U6 and transistor M4. In the course of maintaining the voltage on wire 85, the transistor M4 sources current to resistor Rset, drawing that current from wire 86 with the value Iramp. So the circuitry using R21, R22, Rset, U6, and M4 produces a constant current used to set the ramp rate in the pulse generator, therefore directly controlling the pulse width T1 with an inverse function which determines how long the switch M1 in FIG. 5 stays turned on.

Now suppose that Vp is not zero. As Vp increases from zero, transistor M2 draws increasing amounts of current from wire 83, causing the voltage on that wire to decrease towards zero. That in turn causes Iramp to decrease in proportion. Note that due to the voltage source V0, transistor M3 stays off and does not conduct current. Voltage source V0 is implemented by using a diode connected mosfet and a current sink as known in the state of the art to create a small floating voltage source of 1 to 2 volts value. Any suitable method such as a resistive divider or diode may also be used instead. During this stage of operation the circuit is following the portion of the transfer curve plotted in FIG. 9 denoted as region 1. In this region, the output current drops gradually as Vp increases, eventually becoming lower than Inom by the previously chosen amount of −15%.

As Vp increases, it eventually reaches a value where the voltage drop across M2 is near zero. At that time, M2 cannot continue to operate as a current sink, since increasing its gate voltage in a positive direction will not substantially change the sink current. The amplifier U5 then loses control of the voltage on wire 81, and increases its output voltage to try to compensate. As a result, transistor M3 then turns on, and provides current to pull wire 83 in a more positive direction. Transistor M2 in this case has excess voltage on its gate, and operates as a switch with a small voltage drop. Therefore the voltage at wire 81 has essentially the same voltage as wire 83, and amplifier U5 operates so as to cause M3 to pull up the voltage on wire 83 to correspond to the input voltage Vp. This makes the voltage on wire 83 substantially identical to the voltage Vp when Vp exceeds a chosen value. Keep in mind that Vp is directly related to the AC line sine wave voltage peak value by the circuit previously detailed in FIG. 6. At this input voltage, the operation transitions from region 1 to region 2 in FIG. 9. In region 2, the output current Iramp becomes directly proportional to Vp, and increases when Vp increases. As a result, the pulse generator output pulse width T1 decreases as Vp increases, exactly as needed to hold the power converter output power to the LED load essentially constant, as previously disclosed in equation 311 of FIG. 7. This proportionality will persist for voltages above the transition point at Vnom−5% to voltages greater than Vnom+15%. As a result, the LED brightness will be constant for input voltages around +/−15% of nominal, and varies for input voltages less than Vnom−5%. This characteristic gives the LED lamp replacement the desirable property of constant brightness operation for normal operation, together with the capability of being used with transformer type dimmer systems if desired.

In order to provide compatibility with phase cut dimmers of either the leading edge or trailing edge cut type, it is necessary to provide a minimum amount of current through the LED lamp power supply at all times that voltage is applied. Referring to FIG. 5 again, this function is performed by the comparator U4, which compares the voltage on the current sensing resistor Rcs as sensed on wire 26 with a reference voltage. If a constant voltage is used, such as 150 millivolts, then the peak current of the inductor during time T1 of FIG. 2 will be restricted to always being equal or more than 150 milliamps if Rcs=1.0 ohm. However, when the input voltage Vin is too small, the inductor is not able to charge to this current level in the time T1. As a result, the output of the comparator U4 stays high, and a signal is issued on wire 61 to cause time T1 to be stretched until the comparator reference level is reached. The stretch signal also causes the oscillator to extend its phase when its Trig output on wire 42 is high, so that the pulse generator 41 will not be prematurely terminated.

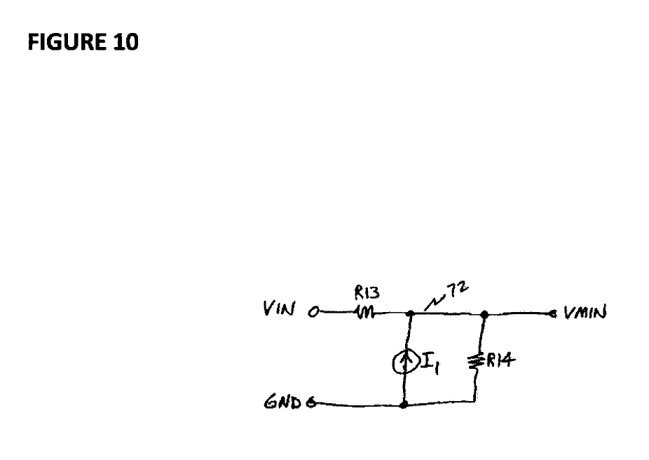

An important consequence of the stretch operation is that the pulse operating frequency is reduced, and time T3 in FIG. 2 is extended. This changes the relative duty cycle proportion between T1 and the remainder of the cycle, affecting the relationship between the average input current and the peak current when stretch is active. For reasons of minimizing line current harmonics and maximizing power factor, it is desirable that during the stretch time, the average line current remains constant instead of the peak power converter current. It has been experimentally found that if the reference voltage for the stretch comparator is composed of a constant voltage value plus a small proportion of the input voltage Vin, the average current can be made nearly constant during the stretch time. The reference voltage Vmin for this purpose is made with the simple circuit shown in FIG. 10. The voltage Vin is divided by the voltage divider composed of R13 and R14 to make the voltage Vmin. A small DC voltage is added to this output by the current I1 created by a mosfet current source as is known in the state of the art. When I1 flows through the parallel combination of R13 and R14 it produces the desired additional voltage as an additive offset. A mathematical derivation has verified that this is the correct change to make to the reference voltage for constant input current averaged over the cycle period T3 as the stretch function is used.

An additional problem in practical application of this power converter is that phase cut dimmer circuits which use an embedded digital control circuit, often times a microprocessor, may require additional power for their operation. Specifically, if the dimmer is designed to replace a 2 terminal switch, without a third wire to the power neutral line, then the power required to operate the digital control circuitry in the dimmer must be drawn through the load circuit, which in this case is the LED light bulb. This auxiliary power current can upset the operation of the power converter being discussed here, or the impedance of the power converter may prevent the digital dimmer circuit from receiving adequate current for proper operation.

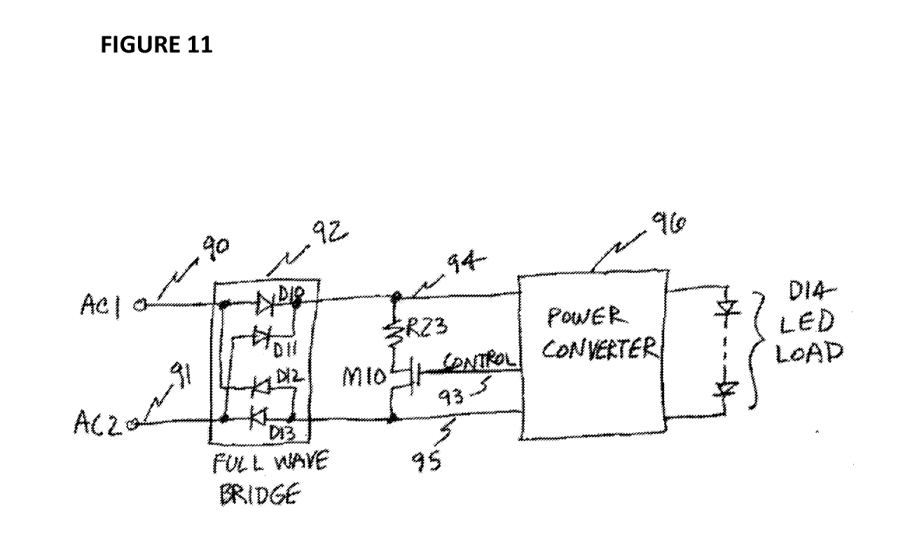

One means for solving this problem used in prior art is to add a switch transistor and an auxiliary load resistor across the input terminals of the power converter as shown in FIG. 11. The AC line input is on wires 90 and 91 as before, and rectified by a bridge rectifier 92 using four diodes D10 through D13 as known in the state of the art. This pulsating DC power is then used to power the voltage converter 96 with its load D14. Details of the voltage converter are not important here. The added circuitry is transistor M10, shown here as an NMOS field effect transistor, but which could be any other type of solid state switch as known in the state of the art. When M10 receives an activation voltage on wire 93, labeled control, it turns on, connecting resistor R23 across the output of the rectifier bridge. In this way, regardless of the amount of power being consumed by power converter 96, it is guaranteed that there will be a minimum amount of load on the AC line voltage source caused by resistor R23. This method has two major disadvantages: 1) The controller has to know when to turn on M10 so as to minimize power loss while still achieving the desired AC line loading, and 2) The power absorbed by R23 is dissipated as heat. Dissipation of power as heat lowers the overall system efficiency and causes thermal problems.

Referring again to FIG. 5, a method for overcoming these problems and still providing digital dimmer compatibility is use of the digital dimmer control (DDC) circuit shown as item 65. The object of this circuit is to monitor the frequency of pulses occurring at the output of the Imin comparator U4, item 33, as it appears on wire 64, and to use this information to modify the reference voltage on wire 63 to the same comparator U4. When the incoming AC line voltage goes through a zero crossing, if a leading edge phase cut dimmer is in use, the voltage will remain at zero for some time after the normal zero crossing time. Phase cut dimmers with digital control usually take advantage of this time in the waveform to draw some power for their own circuits through the load, in this case the LED light bulb. If the LED light bulb power converter treats this power draw as a normal power source to be converted, the digital dimmer will not receive adequate current, and will fail to operate normally.

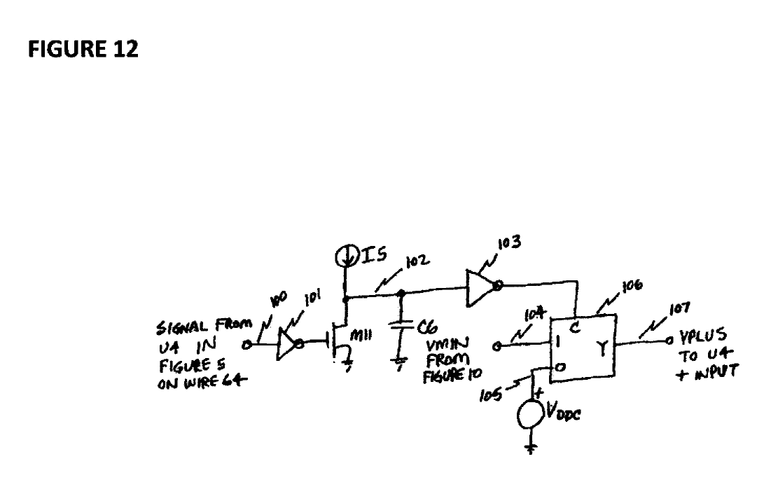

One possible realization of the DDC circuit called for in FIG. 5 is shown in FIG. 12. This circuit works by determining that the AC line voltage is not supporting current in the power converter circuit, as measured by the Imin comparator U4 denoted 33, and shown by the wire 64 of FIG. 5 remaining in an active high logic state for more than a minimum time interval. In FIG. 5 this wire 64 signal is used to cause the pulse generator 41 to stretch the time period T1 and keep the power switch M1 on a longer time. For the circuit presently discussed, this time minimum interval is approximately 50 to 100 microseconds, though that number may be altered as desired without affecting the basic function of the circuit of FIG. 12. The input signal on wire 100 goes through a logic inverter to wire 101 to control the gate of transistor M11. If the time interval is exceeded as measured by the input signal on wire 100 from the output of U4 staying high in an active state, the current source 15 will be able to charge up the voltage on capacitor C6 and wire 102 to the switching threshold of circuit 103. The current source is a simple constant current source as known in the state of the art, although a practitioner could replace it with any other circuit, such as a resistor, which would be able to provide charge to capacitor C6. Circuit 103 may be an inverter or a Schmidt trigger as known in the state of the art, or any other switching circuit with a defined switching threshold. In this realization, the output of the circuit 103 is then used to control an analog switch 106. When the control signal is high, corresponding to the time interval measured by C6 not having expired, the switch chooses the previously generated voltage Vmin on wire 62 in FIG. 5 from the Vmin voltage sample circuit of FIG. 10. When the control signal is low, corresponding to there not having been any low going signals on the wire 100 of FIG. 12, the switch chooses a separate voltage reference Vddc. For the implementation here, the size of the charging ramp on C6 is several volts or more, the Vmin signal on wire 104 goes down to about 50 millivolts near the AC input zero crossing, and the Vddc substitute reference voltage is approximately 0.4 volts. Changing to the separate reference voltage Vddc causes the Imin comparator to allow up to 0.4 amp to pass through the power switch M1 in FIG. 5 before the power converter system resumes operation. This effectively shorts the AC line input wires together so that the power converter can pass the current needed for auxiliary power in the phase cut dimmer with digital control.

Other circuit realizations may be created by a person skilled in the art without altering the basic function of the DDC circuit. The function of the circuit is to recognize that the AC line voltage input to the power converter 96 in FIG. 11 has remained at or near zero volts for a time after a zero crossing, and to provide additional loading to the AC line. The additional loading is created by keeping the switch M1 in the power converter turned on all of the time that there is not sufficient input current and/or voltage to operate the power converter after the zero crossing. This additional loading creates a current transmission path through the power converter to provide the phase cut dimmer with digital control a source of power for its control circuits. When the AC line input resumes a non-zero voltage due to the phase cut time expiring, the power converter will automatically resume operation, and the timer used for the DDC function will reset to zero. Use of the power converter switch to load the AC line input provides power to a two wire digital dimmer without introducing a resistance similar to R23 of FIG. 11, and therefore avoids power loss. Additionally, use of the Imin comparator U4 (item 33 in FIG. 5) to control the switch operation makes the control automatic without requiring special timing measurements of the AC line voltage cycle.

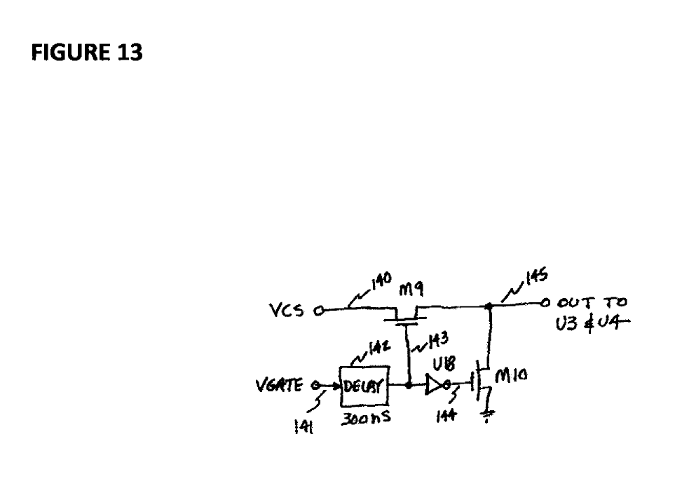

During normal operation of the power converter, the voltage measured on the current sensing resistor Rcs in FIG. 5 will have a large positive going voltage spike each time the switch M1 is turned on. The spike comes from capacitive displacement currents associated with the wire 25 and those components attached to that wire, together with the gate charge of M1 necessary to establish conduction in M1. FIG. 13 shows the leading edge blanking (LEB) circuit 66 which is provided for negating this problem as is well known in the state of the art. This circuit uses a delay timer 142 and an analog switch formed with M9, M10, and U18. The Vgate signal 141 which drives the power switch M1 also starts the delay 142. This delay uses a capacitor loaded inverter as known in the state of the art to create a time delay. After the time delay has expired, a high signal is created on wire 143. Series transistor M9 turns on as a result, and the inverter U18 output on wire 144 goes low, turning off parallel transistor M10. As a result, for a short period after the voltage Vgate is applied to M1, the voltage sent to both comparators U3 and U4 on wire 67 will be near zero. This prevents premature operation of these comparators. The typical delay time for the application shown here is 300 nanoseconds. After the delay time expires, the voltage on wire 67 will be the same as the voltage on wire 26 from Rcs. When Vgate goes away, M9 turns off and M10 turns on again.

During the time when the power converter of FIG. 5 is first starting operation, the capacitor C2 may not have sufficient voltage to meet the requirements of equation 305 in FIG. 3. When this happens, the conditions for discontinuous operation are not met, and the inductor will not fully discharge its current by the end of the time period T3. This is a serious problem, and the excess current can accumulate in inductor L1 and switch M1, causing system overload and failure. In order to prevent this problem, during these startup times the converter is allowed to operate in a continuous operating mode, wherein the inductor current in L1 does not go to zero at the end of each time period T3. Control of the peak inductor current Ipk1 is then done by comparator U3, denoted 32 in FIG. 5, providing a signal Imax which indicates that the inductor current has reached a limit value. The limit value is set by a reference voltage Vrm from a constant voltage source. The present system uses Vrm which gives Ipk1 a maximum value of 0.65 amp, and this value should be changed depending on the desired system power and voltage of the application in question. When Imax becomes active, it goes to the control logic on wire 39 to cause the switch M1 gate drive voltage Vgate on wire 28 to immediately turn off, thereby limiting the current flow through M1. In this way, comparator U3 serves as a safety limiter to control operation of the switch M1 to a safe value when unusual operating conditions are encountered.

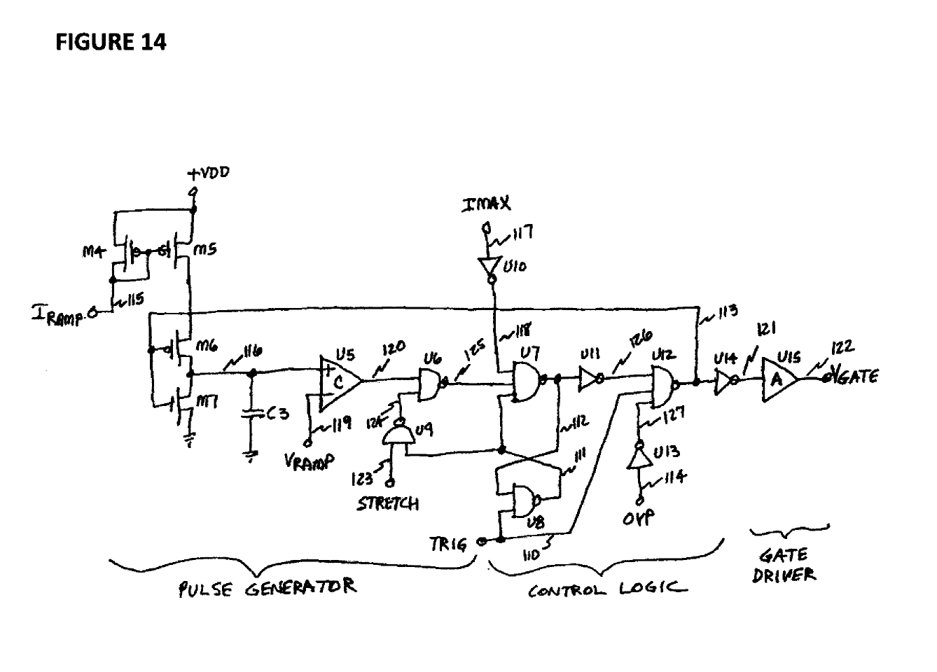

Since the pulse generator 43, control logic 38, and gate driver 34 of FIG. 5 are closely related in their operation, the details of these circuits are shown as a group in FIG. 14. Operation begins with the oscillator signal Trig on wire 110 in an inactive or low state. Assume that the inputs Imax, Stretch, and Ovp are at an inactive low state, a current from Iramp is present in wire 115, and that an appropriate reference voltage Vramp is present. In the circuit discussed here, the values used were 5 microamps for Iramp and 4 volts for Vramp, with a system Vdd of 10 volts. Due to Trig being low, wires 111 and 113 will be high. A high value on wire 113 causes M7 to turn on, discharging capacitor C3 and pulling wire 116 to ground. As a result, the output of comparator U5 on wire 120 is low. Since Stretch on wire 123 is low, wire 124 is always high. Therefore gate U6 operates as a logical inverter, and wire 125 is high. Since Imax on wire 117 is low, wire 118 is high, which together with the high level on wire 111 causes wire 112 to be low and wire 126 is high. Finally, since Ovp on wire 114 is low, wire 127 is high. However, the Trig input on wire 110 is low, so the output of gate U12 on wire 113 is high as before, so the output of U14 on wire 121 is low, and the amplified gate drive on Vgate (wire 122) is low. The power switch is consequently off. This is the quiescent state for the pulse generator and control logic.

Now if the Trig input on wire 110 goes high, it has no immediate effect on the output of gate U8 on wire 111. However, all three inputs to gate U12 are now high, so wire 113 goes low, wire 124 goes high, and the Vgate drive to the switch goes high. This turns on the power switch to start current flowing in L1. At the same time, because wire 113 went low, M7 turns off and M6 turns on, causing a copy of the current Iramp from M5 to begin charging capacitor C3. A positive going linear voltage ramp results on wire 116. Nothing further happens until the capacitor voltage on wire 116 reaches equality with the voltage Vramp at the U5 negative input.

When the voltage on capacitor C3 surpasses the reference voltage Vramp, the comparator U5 changes its output state, with its output going to a logic high level. This is the defining item for the pulse width T1 controlling the power switch conduction. Since wire 120 goes high, the output of U6 on wire 125 goes low, and the U7 output on wire 112 must go high. This changes the state of the set-reset flip-flop formed by U7 and U8, with the alternate output on wire 111 going low because the Trig input on wire 110 is presently high. The output of U11 on wire 126 goes low, causing the output of U12 on wire 113 to go high again. Finally, the output of U14 toes low, and the Vgate output of the gate driver on wire 122 will go low, turning off the power switch. Therefore, when the capacitor voltage of C3 on wire 116 reaches Vramp, the gate drive pulse to the power switch M1 is terminated. As a result of wire 113 going high, transistor M7 turns on again, resetting the voltage on capacitor C3 to near zero.

The general result is that each time Trig goes low to high, there will be a pulse on Vgate to turn on the power switch. The pulse width is defined by the amount of time it takes the current Iramp to charge capacitor C3 up to the voltage Vramp. The amplifier U15 made with several logic inverters as known in the state of the art provides the current necessary to drive the input capacitance of the switch M1, obtaining fast switching which will minimize losses.

Referring again to FIG. 5, the combined circuit of FIG. 14 has several auxiliary inputs. The first is the Stretch input from the comparator U4. This input goes high if the current through the power switch M1 has not exceeded the minimum value desired for proper circuit operation. If the Stretch signal on wire 123 and the U8 signal on wire 111 are both high, the output of gate U9 on wire 124 goes low, causing the output of gate U6 on wire 125 to be unconditionally high. This action prevents the knowledge of the timing done by capacitor C3 and comparator U5 from reaching the flip-flop formed by U7 and U8. Therefore the pulse time T1 is extended until the Stretch signal changes back to a low level.

The stretch activity is performed whenever the current through the power switch M1 is less than a desired level, as measured by resistor Rcs and comparator U4. Use of the stretch signal to force a minimum current is used to cause the power converter to draw a higher average current than would otherwise result from its present instantaneous input voltage V1. This current in turn serves to hold the triac power gate used in some phase cut lamp dimmers in an on state and prevents flickering or failure to light the light bulb.

A second input to the combined circuit of FIG. 14 is the Imax signal on wire 117 as seen in FIG. 5. This signal is generated by comparator U3 whenever the current through the power switch M1 and inductor L1 exceeds a desired current limit. Resistor Rcs is used to measure the power switch current, generating a voltage which is compared against a current limit Vrm. When Vrm is exceeded, Imax becomes high on wire 117 of FIG. 14 and is inverted to a logic low on wire 118 by U10. As a result, the output of U7 on wire 112 must unconditionally go high, ultimately causing the Vgate signal to the power switch M1 on wire 122 to go low. This also causes wire 113 to go high, terminating the pulse being generated. As a result, whenever the maximum current Imax=Vrm/Rcs is exceeded, the power switch M1 is immediately turned off.

A third input to the combined circuit of FIG. 14 is the Ovp signal on wire 114 as seen in FIG. 5. This signal comes from the floating over voltage protection (OVP) circuit 36 in FIG. 5 and is used to protect against excessive voltage across C2 and the LED string D8. Whenever Ovp is high, U13 inverts this to a low logic level on wire 127, forcing the output of gate U12 on wire 113 to go high. This ultimately causes the Vgate drive signal for the power switch on wire 122 to go low, shutting off current conduction in the power switch.

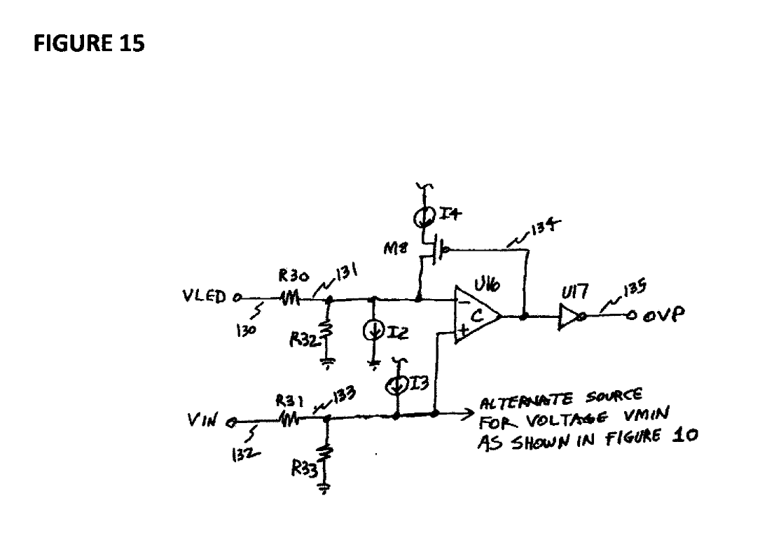

Circuitry for the over voltage protection (OVP) circuit is shown in FIG. 15. The objective of this circuit is to give an output whenever the voltage difference Vled−Vin exceeds a desirable limit value. Operation begins with a matched pair of voltage dividers, the first using R30 and R32, and the second using R31 and R33. Resistors R30 and R31 are nominally identical, and resistors R31 and R33 are nominally identical. Error in the resistor values will cause errors in the operation of the OVP circuit, so normally resistors with 1% tolerance values will suffice to give good circuit operation. Because of the matching, if the input voltages Vled on wire 130 and Vin on wire 132 are identical, then the voltages on wires 131 and 133 would be identical if there were no other circuit elements present. This matching is used to eliminate common mode voltage effects from Vin being non-zero causing erroneous outputs. Comparator U16 compares the voltages on wires 131 and 133 to determine if the OVP threshold has been exceeded.

In order to have a non-zero OVP threshold, a differential voltage must be added to the input signal Vled−Vin. The easiest way to accomplish this is to inject current into wire 133 and pull current out of wire 131. Either one by itself would suffice, but for convenience of implementation, a pair of current source and sink circuits is used. These source and sink circuits use mosfet transistors in a simple circuit as known in the state of the art. The value of 13 is chosen so that when Vin is zero, the voltage on wire 133 is about 1 volt, for convenience of obtaining good operation of the comparator U16. Note also that the voltage so defined can also serve as an alternate source of the voltage Vmin as shown previously in FIG. 10. The circuit of FIG. 10 does not have to be separately used.

The currents I2 and I3 when added together and multiplied by the value of R30=R31 gives the value of the comparator trigger point Vtrovp=Vled−Vin. Therefore choice of the proper values of I2 and I3 can set the OVP trigger point. When that trigger point is exceeded, then the output of U16 on wire 134 will go low. Finally, the inverter U17 causes the Ovp signal on wire 135 to go high when the over voltage condition occurs.

In order to prevent undesired system oscillations, the OVP circuit 36 and FIG. 15 is provided with hysteresis. This causes the OVP trigger point to be larger than the value required for the circuit to reset to a non-triggered state. Hysteresis is obtained by providing positive feedback from the output of U16 to its negative input using transistor M8 and current source 14. When the U16 output goes low on wire 134, it turns on transistor M8, injecting a small current into wire 131. This alters the voltage balance equations, causing the voltage at the comparator negative input to go slightly higher. As a result, the voltage at Vled must drop to a lower level than the trigger point to turn the OVP signal back off. For the example circuit here, the OVP trigger point is at a differential voltage of 120 volts, and the hysteresis causes the voltage to have to drop to 100 volts to turn off the OVP signal. These trip points and hysteresis value are set by the sizes of the two current sources I2 and I3, and sink and I4 in conjunction with the resistor values R30 and R31. R32 and R33 serve mainly to control the common mode and differential voltage magnitudes presented to the comparator U16.

The entire system as discussed previously is sufficient for a power converter to power LEDs and replace a standard tungsten light bulb. However, in some cases, the bulb being replaced is a “three way” light bulb, capable of putting out three different intensities. Three way light bulbs incorporate two filaments and an extra contact on their base to permit choice of three different brightness levels in a standard light fixture. For a standard three way light bulb, the fact that there are only two filaments creates the limitation that there are only two independently settable brightness levels, with the third and brightest level being the summation of the first two. That is, if you label the brightness of the two filaments as A and B (usually described by their power dissipation in watts), then the third brightness level available is A+B. The bulb has three contacts, a tip, a ring, and the screw base shell. Usually the tip is the brightest filament and the ring is the dimmer filament. A switch in the lamp socket connects one side of the AC line input to either the ring, the tip, or the tip and ring together in that sequence to energize the lamp. The other AC line input connects to the screw base.

For the purpose of operating correctly in a three way lamp socket, additional circuitry is provided. As seen in FIG. 5, a pair of voltage dividers using R1 through R4 is used in conjunction with noise filters, a three way control circuit, and a digital to analog converter (DAC). The voltage dividers reduce the line voltage amplitude to suitable values for the power converter circuits, using R1 and R3 for one divider, and R2 and R4 for the other divider. These dividers are similar, with resistor tolerances of up to 5% being acceptable. Relative to the circuit ground reference, an approximate sine wave voltage at the input frequency will be present on the wires 51 and 52 if the AC line is connected to the corresponding ring (wire 22) and tip (wire 21) terminals of the lamp.

The noise filters 53 and 54 are used to reduce the possibility of false operation caused by short pulses of high frequency noise on the incoming AC line. This noise often occurs from sources such as triac lamp dimmers and household appliances. Noise filtering may be done with a simple RC low pass filter using a series resistor and a parallel capacitor as known in the state of the art. Other more elaborate filtering schemes may be used instead, involving more elements, inductors, or even non-linear devices such as diodes as known in the state of the art. Any method which reduces the noise impulses seen on the AC line is sufficient. The circuit here will operate correctly in the absence of noise without using noise filters, but impulse noise on the AC line may cause errors if filters are not used.

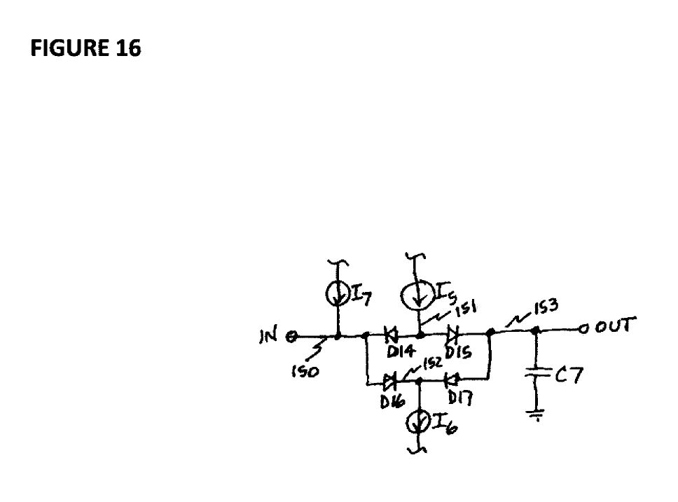

FIG. 16 shows a particular type of non-linear filter implemented in the circuit disclosed here. Use of this non-linear filter has the advantage that it eliminates the need for a long time constant, which requires large resistors and capacitors for monolithic integration and consumes a large amount of valuable silicon area. A filter could be external to the integrated circuit, but it is desirable to minimize the number of external components. This filter has the feature that it limits the rate of rise and fall of the output voltage on wire 153 regardless of the amplitude of the input voltage on wire 150. When the input voltage on wire 150 is quiescent or slowly changing, diodes D14 through D17 all conduct approximately equal amounts of current. The low dynamic impedance of the diodes connects the capacitor C7 to the input voltage on wire 150, so that the voltage on wire 153 following the input voltage on wire 150 with only a small difference. Current source 15 and current sink 16 have equal magnitudes and are provided to cause a bias current to flow through the diodes D14 through D17. When an input voltage on wire 150 has a rate of change which would cause the charging or discharging current of capacitor C7 to exceed the current available from source 15 or sink 16, some of the diodes in the circuit of FIG. 16 will turn off. As a result, the rate of change of the voltage on capacitor C7 will be limited by the values of the current source 15 or sink 16. This causes fast changing voltage spikes on the input wire 150 to be severely attenuated in amplitude, and keeps them from affecting the following circuitry. Finally, an optional current source 17 is provided in this example to unbalance the current at the input wire 150. This causes the voltage on wire 150 to be pulled up towards the circuit Vdd supply voltage if the wire 150 is not connected to any external circuitry. Therefore the voltage is forced into a default state if no connection to wire 150 is provided. All current sources and sinks are made using mosfet transistors as known in the state of the art.

The three way control denoted 55 in FIG. 5 is the subject of a separate invention disclosure, U.S. patent application Ser. No. 13/451,457, “Circuit for Detection and Control of LED String Operation,” filed on Apr. 19, 2012, which is incorporated by reference herein. Circuit block 55 takes in two sine wave signals on In1 and In2 and outputs two digital signals Q1 and Q2 to denote which of the three brightness operating modes is in use. The circuit incorporates memory so that even though the incoming signals on wires 51 and 52 are approximate sine waves at the 60 Hz AC line frequency, the output signals Q1 and Q2 on wires 68 and 69 are constant logic levels. For example, Q1 on wire 68 may be high if there is AC line voltage on the base ring and wire 22, eventually going to In1 after noise filtering. Q2 on wire 69 may be high if there is AC line voltage on the base tip and wire 21, eventually going to In2 after noise filtering. Output Q1 is high if there is a signal at In1, and output Q2 is high if there is a signal at In2. If both In1 and In2 have signals present, then both outputs Q1 and Q2 will be logic high. When the power converter system is first started up, a signal from the UVLO in the shunt regulator causes both outputs Q1 and Q2 of the three way control to go high until a signal is received on the ring input AC1 on wire 22. With this feature, a light bulb replacement using this power converter circuit may be used in either a standard socket or one using a three way switch. In the standard socket, the lamp will light up to full brightness even though the power is coming only from the tip (AC2) of the lamp base. As soon as power is received on the ring connection AC1, the power converter reverts to three way control as desired. Power can be received on AC1 only if the lamp is installed in a socket made for a three way light bulb, and the appropriate brightness level is selected by the associated switch.

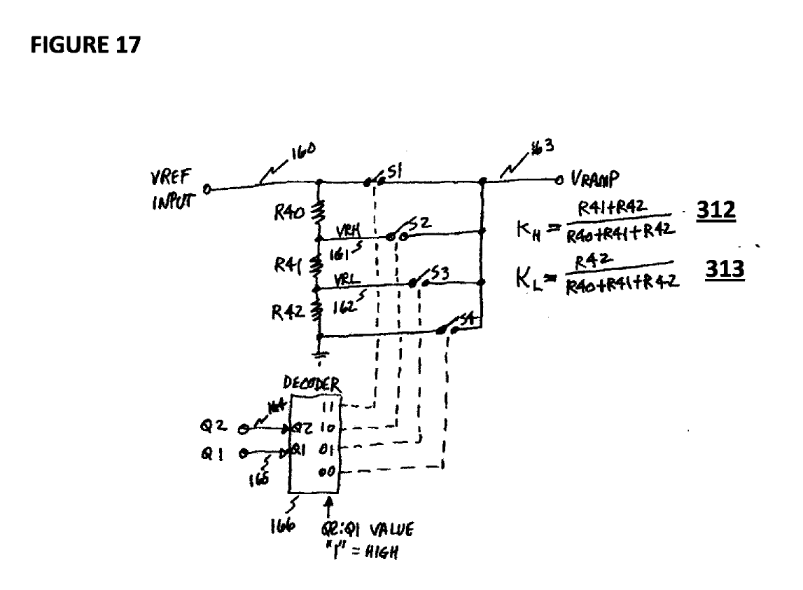

The output signals Q1 and Q2, which tell which brightness level to use, go next to a digital to analog converter (DAC) denoted as 56 and shown in FIG. 17. This converter produces one of four voltage levels at its output depending on the logic states of Q1 and Q2. An input reference voltage Vref is input on wire 160, going to a switch Si and a resistor R40. The series string of three resistors R40, R41, and R42 is used to divide the reference voltage Vref to make two new values Vrh and Vrl. These voltages are predetermined values for the desired intermediate light bulb brightness levels. Note that the summation relationship of P1+P2=P3 mentioned previously and which is present in a standard incandescent three way light bulb is not present here. The two intermediate brightness levels may be independently and arbitrarily chosen to suit the application anticipated, and do not have to be related to the maximum bulb brightness. This voltage divider can be seen as implementing a way to change the value K previously introduced in FIG. 3 and shown in FIG. 4, equation 307 to relate to the output power of the light bulb power converter. The voltage scaling factor K required is proportional to the square root of the output power P of the power converter as shown there. In FIG. 17, equations 312 and 313 are shown to relate the scaling factors Kh and Kl to the resistor values. These two factors are just the brightness scaling factors for reduced brightness control, and there are other factors which also enter into the final value of K in equation 307.

Voltage Vrh from the tap between R40 and R41 goes on wire 161 to switch S2, and voltage Vrl from the tap between R41 and R42 goes on wire 162 to switch S3. Switch S4 connects to ground for the case when both Q1 and Q2 are logic low. This last case is only included for completeness, and does not happen in actual usage of the power converter, since if Q1 and Q2 were both low, there would not be any AC line power being supplied to the power converter. Control of the four switches Si through S4 is done by a logic decoder 166 made as known in the state of the art. The input signals Q1 and Q2 cause one of the four decoder outputs to be a logic high, and the three remaining outputs to be a logic low. The high decoder output turns on its associated switch, selecting a voltage that is output on wire 163 for the signal Vramp required by the pulse generator 41 in FIG. 5. The switches Si through S4 may be simply implemented using an analog transmission gate incorporating mosfet transistors, bipolar transistors, diodes or other means known to the state of the art. In the present implementation, cmos analog transmission gates are used with complementary pairs of nmos and pmos transistors.

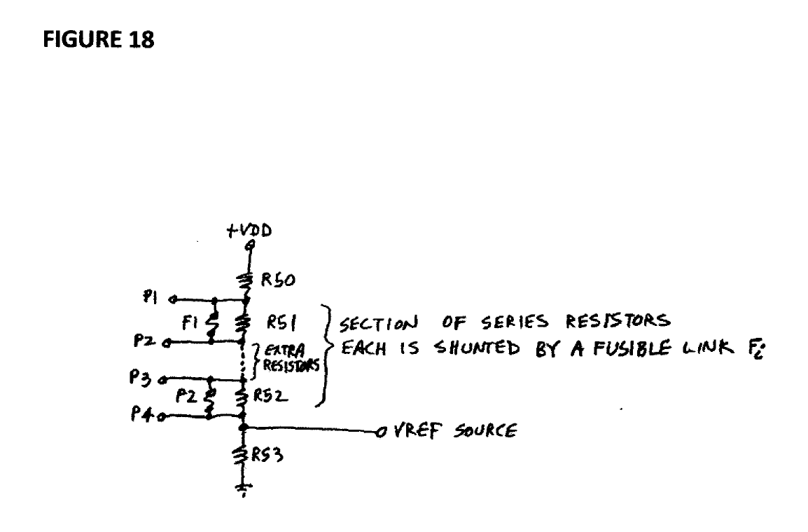

Factory trimming of the power output of the voltage converter is done by the factory trim circuit 59. This circuit uses a simple resistive divider as shown in FIG. 18 which incorporates fusible links for changing the effective output voltage. After the integrated circuit realizing the majority of the blocks of FIG. 5 is manufactured, the operating properties are measured. Changes to the pulse timing may be made by causing selected fusible links in FIG. 18 to become open circuits, thereby changing the voltage divider ratio and altering the value of Vref. Resistors R50 and R53 represent the fixed portions of the voltage divider, and resistors R51 and R52 represent some of the multiplicity of programmable resistor sections. Programmable resistors may have various values to make achievement of the desired final value easier. Each of the multiplicity of resistors in the programmable section has a shunt fuse shorting it out, represented by F1 and F2. Application of a sufficient current to a particular fuse by use of auxiliary contact pads P1 through P4 and an external voltage source will cause the metal of the chosen fuse to melt, and the fuse becomes an open circuit. Therefore after measurement of the operating properties of the power converter, selected fuses may be caused to be an open circuit, setting the final operating properties at the desired value. In this design, the trimmed reference voltage Vref is used to both adjust the width of the pulse generator 41 output by changing Vramp, as well as in combination to change the oscillation frequency of oscillator 43 in FIG. 5. Choice of controlling both in combination is made to compensate for some types of manufacturing variations which will be common to both circuits.

Referring again to FIG. 5, the resistor 49 labeled Rset is an important feature. In one implementation this resistor is installed in the application circuit, external to any integrated circuit which may be used to realize other parts of the power converter. The user of the integrated circuit may then make adjustments to the value of Rset resistor 49 in order to change the charging current Iramp for the pulse generator 41. By this means, the output power of the power converter feeding the LED lamps in FIG. 5 may be changed. This adjustment allows for making the light output constant if desired, or standardization of the power input from the AC line. The factory trim is done to remove errors due to integrated circuit manufacturing tolerances, and the user trim with Rset is done to remove errors due to the tolerances of the various components in the application circuit. The most significant user component for causing power errors is L1, as can be seen by looking at equation 306 of FIG. 3. The resistor Rset may be chosen to match the known value of inductor L1 to get constant power.

In a more integrated design, it is feasible for the factory trim of FIG. 17 and the user trim of Rset of FIG. 5 to both be incorporated into the integrated circuit realization. Electronic trimming structures accessible with digital logic signals would be provided on the integrated circuit, so that the trim adjustments may be made, tested, and caused to be permanent all by simple signals. The signals would make alternate usage of signal pins otherwise on the chip, so that additional package pins are not required. This minimizes the difficulty of getting the LED lighting system to operate as desired, and introduces the additional benefit that the user trim can be done after the entire system is assembled and operational. Trimming could be done with the LED lighting system power converter in operation. In this case, the user can choose to electronically adjust the LED system as desired, optimizing the power converted, light output, or some other desirable parameter. In an integrated manufacturing facility, machines could completely assemble the electronic light bulb using the above described LED lighting system and power converter, connect to the trim adjustments, and individually and permanently adjust each light to produce standardized performance. This level of automation would give the highest and best possible result at the lowest cost to the consumer, for a product with a very large potential manufacturing volume.

The means which has been described here is a new method for power conversion of the AC line voltage to the voltages required by LED lighting systems, providing simplicity, small size, low cost, and efficiency. This method meets all the common requirements for compatibility with line powered tungsten lamp systems, so that tungsten filaments lamps may be replaced with units using LED light emitters. Provisions are made for high power factor operation and compatibility with the majority of the types of lamp dimmers in common usage. Features also available give operational functionality in systems using three way tungsten lamp bulbs. Although all the description above makes reference to the AC line as the source of primary electrical power, any person skilled in the state of the art can recognize that this power converter circuit may also be used with constant or pulsating DC input, or other alternating voltage waveforms which are more complex than the sine waves generally delivered by the common AC line power source. Specifically, the non-sinusoidal output of some DC to AC converters can be accommodated without any difficulties, and the DC output from a source such as a battery or a solar cell array may also be used.

References to the present invention herein are not intended to limit the scope of any claim or claim term, but instead merely make reference to one or more features that may be covered by one or more of the claims. Materials, processes and numerical examples described above are exemplary only, and should not be deemed to limit the claims. It should be noted that, as used herein, the terms “over” and “on” both inclusively include “directly on” (no intermediate materials, elements or space disposed there between) and “indirectly on” (intermediate materials, elements or space disposed there between). Likewise, the term “adjacent” includes “directly adjacent” (no intermediate materials, elements or space disposed there between) and “indirectly adjacent” (intermediate materials, elements or space disposed there between). For example, forming an element “over a substrate” can include forming the element directly on the substrate with no intermediate materials/elements there between, as well as forming the element indirectly on the substrate with one or more intermediate materials/elements there between.

1. A voltage converter for generating a high power factor voltage, comprising:
a bridge rectifier for rectifying alternating current from a power source;
an inductor coupled to the bridge rectifier;
a switch for applying an input voltage to the inductor; and
an oscillator for controlling the switch;
wherein the voltage converter outputs a voltage with a high power factor.

2. A voltage converter for driving a plurality of light emitting diodes, comprising:
a bridge rectifier for rectifying alternating current from a power source;
a peak detection circuit coupled to the bridge rectifier for identifying peaks in an output of the bridge rectifier;
an inductor comprising a first end and a second end, wherein the first end is coupled to the bridge rectifier and the second end provides an output voltage for driving a plurality of light emitting diodes;
a switch comprising a gate, a first terminal, and a second terminal, wherein the first terminal is coupled to the inductor;
a resistor coupled to the second terminal; and
a control circuit coupled to the gate for controlling the switch, wherein the control circuit comprises:
an oscillator;
a pulse generator that receives a signal from the oscillator and a signal from a shaper circuit, wherein the shaper circuit receives a signal from the peak detection circuit;
control logic that receives a signal from the pulse generator; and
a gate driver that receives a signal from the control logic, wherein the gate driver is coupled to the gate.

3. The voltage converter of claim 2, further comprising:
one or more noise filters coupled to the bridge rectifier.

4. The voltage converter of claim 2, further comprising:
a trim circuit coupled to the oscillator for adjusting a frequency of the oscillator and a width of the pulse generator.

5. The voltage converter of claim 4, wherein the trim circuit comprises a plurality of fusible links.

6. The voltage converter of claim 2, further comprising:
a charge pump for providing a voltage used by one or more components of the voltage converter.

7. The voltage converter of claim 2, further comprising:
an over voltage protection detector coupled to the control logic.

8. The voltage converter of claim 2, further comprising:
a digital dimmer control circuit coupled to the pulse generator for adjusting the period in which the gate is activated.

9. The voltage converter of claim 2, further comprising:
a shunt regulator for controlling the voltage applied to the various control circuits used to implement the voltage converter.

10. The voltage converter of claim 2, further comprising:
a current sensing circuit for detecting when said switch draws excessive current and provided with the ability to limit said current by turning off said switch.

11. The voltage converter of claim 2, further comprising:
a current sensing circuit for detecting when said switch draws less than a predetermined value of current during its conduction time, and which causes said switch to remain in a conducting state until said current satisfies the predetermined current value.

12. The voltage converter of claim 2, further comprising:
a logic control block with a multiplicity of inputs for detecting if said power converter has more than one voltage input, and outputting control signals determined by the combination of inputs in use.

13. The voltage converter of claim 2, further comprising:
a digital to analog voltage converter for generating an additional control voltage for said pulse generator determined by the combination of voltage inputs in use.

14. The voltage converter of claim 2, further comprising:
control logic arranged to cause the input impedance presented to the input voltage source to be substantially resistive.

15. The voltage converter of claim 2, further comprising:
a chosen control function for said shaper circuit such that the power output of said power converter is substantially constant when the input voltage to said power converter is varied over a range of values.

16. The voltage converter of claim 3, further comprising:
noise filter means which incorporate non-linear circuit elements.

17. The voltage converter of claim 2, further comprising:
signal processing means which incorporate non-linear circuit elements.

18. The voltage converter of claim 2, further comprising:
a timer circuit for increasing the minimum current conduction required in said switch during a predetermined time after the said power converter input voltage goes to zero.

19. The voltage converter of claim 2, further comprising:
a leading edge blanking circuit for filtering a sense voltage representing the conduction current flowing through said switch.

20. The voltage converter of claim 7, further comprising:
hysteresis circuits provided for said over voltage circuit.

21. The voltage converter of claim 4, further comprising:
trim circuits made such that the trim operation may be performed by electrical means after said power converter control circuit is placed in its package.

22. The voltage converter of claim 2, further comprising:
trim circuits arranged such that the operating parameters of said power converter may be electrically adjusted more than one time.
